(19) United States
(12) Patent Application Publication
(10) Pub. No.: US 2016/0027126 A1
(43) Pub. Date: Jan. 28, 2016

(54) MANAGED BANK ACCOUNT SYSTEM FOR USE IN RECONCILIATION SERVICES

(71) Applicant: Alden J. Blowers, Pasadena, CA (US)

(72) Inventor: Alden J. Blowers, Pasadena, CA (US)

(21) Appl. No.: 14/340,315

(22) Filed: Jul. 24, 2014

(51) Int. Cl. G06Q 40/00

(52) U.S. Cl. CPC G06Q 40/123; G06Q 40/06

(57) ABSTRACT

A managed bank account system that receives payroll tax files from a payroll provider system is described. The payroll tax files include payroll tax transaction and tax funding data for a plurality of employers and tax authorities. The system also receives transaction feedback data, where the transaction feedback data provides completion and error information on payroll tax clearing house transactions and check transactions between the plurality of payroll providers/employers and at least one tax authority. The check transactions are based on accounts controlled by the managed bank account system. The system creates a ledger for each employer using the transaction data from the payroll tax files and generates a reconciliation report by matching transaction feedback data with each employer and comparing transaction feedback data with the ledgers of an employer. The system provides the reconciliation report to the payroll provider system based on both the clearing house and check transactions.

The embodiments of the invention relate to a managed bank account system that is used for tax settlement services. Specifically, the embodiments of the invention relate to an automated tax settlement service that generates reconciliation reports on a per employer basis based on both automated clearing house (ACH) transactions and transactions made by checks issued by a payroll provider system and/or a payroll employer system.

### BACKGROUND

Automated payroll services systems are provided to end users (e.g., businesses and similar organizations) via a vendor (e.g., a ‘payroll service provider,’ which is a business that sells automated payroll services to their clients who are employers). The employer and/or automated payroll service provider's systems must interact with and use multiple service providers in order to carry out financial transactions related to payroll processing including tax payment processing, tax funding processing, investment of funds, general banking services, and similar financial transactions.

The processing of payroll by an employer and payroll service provider includes taxes (local, state and federal) that are paid to the appropriate tax authority by using automated clearing house (ACH) transactions to transfer funds. Banks return feedback on the success of the transactions, but provide no reconcilement services related to tax settlement. Payroll service providers are unable to easily reconcile tax transactions on a per employer basis based on transaction feedback data provided by banks, because of the minimal transaction data provided by banks. Further, banks cannot provide per employer transaction feedback data because they do not process payroll tax payment documents that define the relationship between the transactions and the employers. As a result, payroll service providers must either manually match many pieces of transaction feedback data and payroll tax data to reconcile these activities or enlist a payroll tax settlement provider to assist in reconciling accounts.

The process of reconciliation is further complicated by the use of physical checks to transfer funds. For example, certain tax authorities may only accept transfers of money through checks. In these situations, payroll service providers and/or employers issue checks to these authorities. Since the checks are drawn on a banking institution separate from a payroll provider, the payroll provider is unable to track many of these transactions, which in turn causes reconciliation problems.

### BRIEF DESCRIPTION OF THE DRAWINGS

The embodiments of the invention are illustrated by way of example and not by way of limitation in the figures of the accompanying drawings in which like references indicate similar elements. It should be noted that references to an or “one” embodiment of the invention in this disclosure are not necessarily to the same embodiment, and they mean at least one.

FIG. 1 is a diagram of one embodiment of a network, including a managed bank account system.

FIG. 2 is a flowchart of one embodiment of the tax settlement process.

FIG. 3 is a diagram of one embodiment of the managed bank account system.

FIG. 4 is a data flow diagram for checking information according to one embodiment of the managed bank account system.

FIG. 5 shows a graph of available funds for a payroll provider system over a forecast time period.

### DETAILED DESCRIPTION

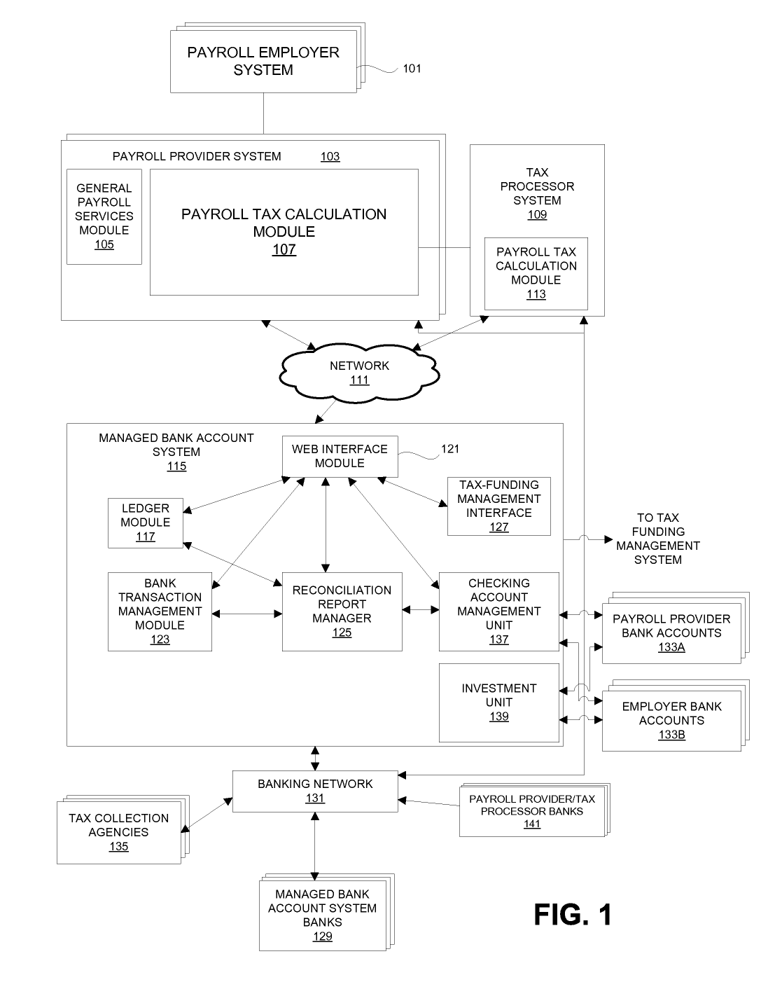

FIG. 1 is a diagram of one embodiment of a managed bank account system 115. In one embodiment, a payroll tax settlement service is provided by the managed bank account system 115, which services a set of payroll provider systems 103 and ultimately a set of payroll employer systems 101. A ‘set,’ as used herein, refers to any positive whole number of items including one item. A payroll provider system 103 is a system of a payroll service provider, which as used herein can refer to any one of a software company providing payroll software, a proprietary or in-house payroll system of an employer, payroll software system provided as a service, a payroll service separate from the employer or similar payroll provider system. For sake of convenience and clarity, the embodiments described herein are in reference to a payroll provider system 103 that is a payroll software service separate from an employer's payroll system 101. One skilled in the art would understand that the principles and structures described herein are applicable to the other types of payroll provider systems.

The managed bank account system 115 can include any number of computing devices including dedicated servers, desktops, laptops and similar computing devices. The managed bank account system 115 can communicate with the set of payroll provider systems 103 over a network 111. In other embodiments, the managed bank account system 115 can communicate or receive payroll data, tax data, and funds from a payroll provider system 103 through manual exchange and input of documents or a similar data exchange or any combination thereof. The payroll provider system 103 receives payroll data and/or funds from the payroll employer systems 101. The payroll employer systems 101 can be in communication with the payroll provider system 103 over a network and exchange data/funds through a direct/automated system or can exchange data by manual input. In other embodiments, any combination of direct and indirect/manual techniques may be used to exchange data/funds between the payroll employer systems 101 and the payroll provider system 103.

The payroll employer system 101 can be any type of computing device or set of computing devices that execute any payroll software. The payroll software can generate and output payroll data for the employees of the employer that operates the respective payroll employer system 101. The payroll data can define wages and salaries and similar information for a given time span. In some embodiments, this payroll data can include retirement account (e.g., 401(k) account) data, garnishment data, worker's compensation data, and similar payroll related data.

The payroll provider system 103 can include a general payroll service module 105 and a payroll tax calculation module 107. The payroll provider system 103 can be executed by any computing device or set of computing devices including dedicated servers, desktop computers, laptop computers, and similar computing devices. The general payroll services module 105 processes payroll employer system 101 data and generates standard payroll data for the employers and returns the payroll data to the employers. The general payroll services module 105 can also execute or initiate transactions to effect the transfer of funds related to the payroll by moving funds between bank accounts or generating checks. In one embodiment, the general payroll services module 105 can communicate and coordinate with the payroll tax calculation module 107.

The payroll tax calculation module 107 generates the local (e.g., county and municipal), state, and federal tax data for each employer and each of their employees and generates a set of financial transactions (e.g., ACH transactions) and check transactions to be executed by payroll provider bank accounts 133A in order to transfer the appropriate funds from the payroll provider bank accounts 133A to the tax collection agencies 135. These transfers can include yearly and quarterly tax withholding, social security and medical and similar withholding and payroll taxes. In this process, the payroll tax collection module 107 can generate a set of tax data files, tax funding files, and tax disbursement files. In these embodiments, the payroll provider bank accounts 133A may be funded from employer bank accounts 133B.

The tax data files, tax funding files, and tax disbursement files detail the transactions and parties involved in the transactions. In one example embodiment, these files can include tax processor identification information, payroll processor identification information, employer identification information, tax processor bank identification information, payroll processor bank identification information, employer bank identification information, payroll instance identification information, payroll liability identification information (i.e., specific payments or transactions to pay tax liabilities for a particular payroll instance, this can be on a per bank account basis), employer draft information (i.e., the details of transactions such as ACH transactions and check transactions to obtain funds to cover tax liabilities from employer banks and similar transactions, this can be on a per bank account basis), tax payment information (i.e., the details of transactions such as ACH transactions and check transactions to transfer funds to tax authorities to cover tax liabilities for employers, this can be on a per bank account basis), bank account balance information, tax code information, and similar information. This information can be provided in a single formatted file or any combination of separate files.

In one embodiment, the payroll provider system 103 works in conjunction with a tax processor system. In this embodiment, the payroll provider system 103 does not process all payroll tax matters and these payroll tax matters are sent to a tax processor system 109 to be processed. In this embodiment, the tax processor system 109 includes a payroll tax calculation module 113 to perform some or all of the actions set forth above in regard to the payroll tax calculation module 107 of the payroll provider system 103. For sake of clarity and convenience, the embodiments herein are described primarily in relation to the embodiment where the payroll provider system 103 performs the payroll tax processing. One skilled in the art would understand that these functions or a subset thereof could be performed by a separate tax processor system 109.

The payroll provider system 103 or tax processor system 109 can provide the payroll tax files (e.g., the tax data files, tax funding files and tax disbursement files) to the managed bank account system 115 over the network 111. Network 111 can be any type of network including a local area network, a wide area network, such as the Internet or a similar network. The network 111 can include any number of wired or wireless connections and any number of intermediate computing or networking devices. In other embodiments, these data files can be transferred through physical media including data storage devices and similar media.

The managed bank account system 115 includes a web interface module 121, a ledger module 117, a bank transaction management module 123, a reconciliation report manager 125, a checking account management unit 137, an investment unit 139, and a tax funding management interface 127. The managed bank account system 115 can be implemented in a set of computing devices including dedicated servers, desktop computers, laptop computers, work stations and similar computing devices. The components of the managed bank account system 115 can be distributed across any number of computing devices.

In one embodiment, the payroll tax files are received from the payroll provider system 103 through a web interface module 121. In other embodiments, the managed bank account system 115 receives the payroll tax files through other electronic transmission mechanisms, through physical media transfer or through manual transmission of the data. The web interface module 121 can be any type of web server or similar type of web based interface that provides a set of web pages through which a payroll provider can access and upload payroll tax files as well as receive and manage reconciliation reports. In one embodiment, the web interface module 121 can pass received payroll tax files to the ledger module 117 and tax funding management interface 127. The web interface module can sort or parse the incoming payroll tax files to identify the tax funding management related files and forward those files to the tax funding management interface 127.

The tax funding management interface 127 is an aspect of the managed bank account system 115 whereby the managed bank account system 115 assists in the processing of tax funding management for payroll provider or employer, which is handled by an external tax funding management system component that are separate and discrete applications that can be remote from the tax settlement system. The tax funding management interface 127 communicates with the external tax funding management system and provides copies of the received tax funding management related files to be processed by the tax funding management system. These tax files and other payroll tax files are also provided to the ledger module 117, which sorts these files per employer and generates a ledger of the balances for each employer for each state, local and federal tax agency to which the individual employers and their respective employees are paying taxes or transferring withholdings. The ledger module 117 creates a separate ledger or set of ledgers for each employer and maintains these ledgers as new tax data files that are received from the payroll provider system. In some embodiments, these ledgers track non-tax related payroll data that affects balances in accounts through which tax transactions are executed.

The managed bank account system 115 also includes a bank transaction management module 123. The bank transaction management module 123 receives transaction feedback data from the banking network 131 related to the tax transactions initiated by the payroll provider systems 103 and/or the payroll employer systems 101. The payroll provider bank accounts 133A, the employer bank accounts 133B, and nodes within the banking network 131 (e.g., tax collection agencies 135 and/or the tax settlement system banks 129) process the tax transactions that transfer the funds from the payroll provider bank accounts 133A and/or the employer banks accounts 133B to the tax collection agencies 135 and generate notices of the successful execution of these transactions and/or any failures in these transactions as well as the details of these transactions that are sent to the bank transaction management module 123. In some embodiments, the banking accounts through which these tax transactions are processed also include other payroll related funds. In these embodiments, transactions related to other payroll transactions including garnishment, retirement accounts (e.g., 401(k) accounts), worker's compensation and similar payroll transaction are monitored and the results of these transactions are provided in the transaction feedback data.

In one embodiment, a checking account management unit 137 maintains the payroll provider bank accounts 133A and/or the employer bank accounts 133B. The payroll provider bank accounts 133A and/or the employer bank accounts 133B may be issued by the checking account management unit 137 to payroll providers and employers via the web interface module 121 or another interface. For example, upon an employer initially registering with the managed bank account system 115 directly or via the payroll provider system 103, the checking account management unit 137 may establish an employer bank account 133B for the employer. The checking account management unit 137 may perform various functions to further maintain established bank accounts 133A and 133B for payroll providers and/or employers. For example, the checking account management unit 137 may record/track deposits and debits to the accounts 133A and 133B, issue statements to employers for the accounts 133A and 133B, facilitate checking services, and perform other related functions.

Although shown as the payroll provider bank accounts 133A and employer bank accounts 133B connecting to the checking account management unit 137 directly, in other embodiments the back accounts 133A and 133B may indirectly communicate with the checking account management unit 137. For example, in some embodiments, the payroll provider bank accounts 133A and/or the employer bank accounts 133B may communicate with the checking account management unit 137 through the banking network 131. In this embodiment, the payroll provider bank accounts 133A and/or the employer bank accounts 133B may be partially maintained by banking institutions that are separate from the managed bank account system 115. These external banking institutions may report activity on each of the bank accounts 133A and 133B to the checking account management unit 137 such that check and other transactions corresponding to the accounts 133A and 113B may be recorded and/or monitored by the checking account management unit 137.

As noted above, in one embodiment, the checking account management unit 137 may provide checking services to employers using the bank accounts 133A and 133B. In this embodiment, the checking account management unit 137 may issue checks or software and/or hardware for employers to generate and print checks for transferring funds to other entities (e.g., the tax collection agencies 135 and/or the managed bank account system banks 129). In this embodiment, the checking account management unit 137 allows the payroll providers and/or employers to issue checks to recipients from funds associated with payroll provider bank accounts 133A and/or employer bank accounts 133 that are managed by the managed bank account system 115. By providing checking capabilities, the managed bank account system 115 is allowed greater visibility in performing reconciliation services for employers. In particular, in previous systems, checks issued by payroll providers or employers were not visible to reconciliation systems provided by third parties. In particular, banks handling checking services provide minimal pieces of information for matching transactions with transaction feedback data. By allowing the managed bank account system 115 to manage these payroll provider bank accounts 133A and/or employer bank accounts 133B, the reconciliation report manager 125 may monitor checking transactions for these payroll provider bank accounts 133A and employer bank accounts 133B such that these checking transactions may be accounted for during reconciliation processing.

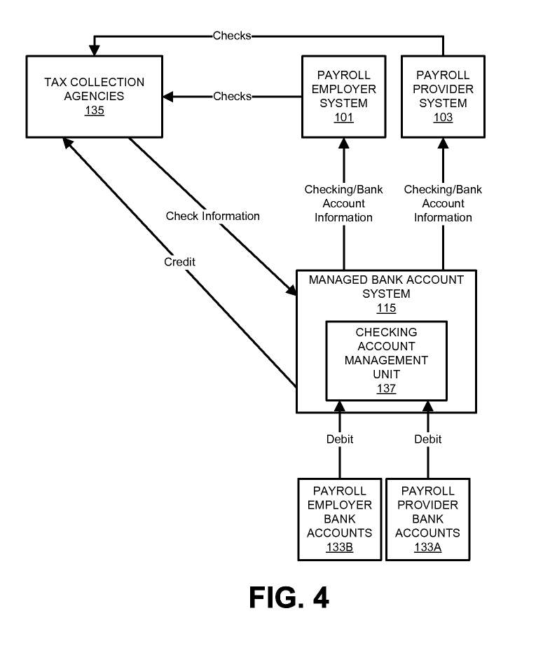

For example, as shown in FIG. 4, the checking account management unit 137 of the managed bank account system 115 may provide information related to the bank accounts 133A and 133B to the payroll employer system 101 and/or the payroll provider system 103. This information may be used by employers for issuing checks from the bank accounts 133A and 133B controlled by the managed bank account system 115 to tax collection agencies 135. The information from these checks (e.g., check number, routing number, bank account number, amount of check, etc.) may be transferred from the tax collection agencies 115 to the checking account management unit 137 of the managed bank account system 115. The checking account management unit 137 may thereafter debit a corresponding bank account 133A and 133B by the amount indicated on the check issued by the payroll provider or employer. Accordingly, as described above, the checking account management unit 137 of the managed bank account system 115 may be aware of each check transaction of the payroll provider and/or employer such that reconciliation services provided by the managed bank account system 115 have a full view of each transaction (i.e., checking and automated transactions) made by the payroll provider and/or employer.

In one embodiment, the checking account management unit 137 may record check transactions (e.g., withdrawals and deposits) in relation to the bank accounts 133A and/or 133B for each payroll provider and/or each employer. The checking account management unit 137 may report these check transactions to the bank transaction management module 123 to accommodate this transaction tracking.

Reconciliation report manager 125 matches and compares the transaction feedback data received through the bank transaction management module 123 and the checking account management unit 137 with the ledgers generated by the ledger module 117. The transactions are sorted and matched with the payroll tax transaction information in the ledgers to verify the accuracy of each of the completed transactions and to ensure that the ledgers are accurate. Any errors or inconsistencies are also tracked. These comparisons or reconciliation of the ledgers and the transaction feedback data are utilized to generate reconciliation reports on a per employer basis by the reconciliation report manager 125. These reconciliation reports are then provided back to the payroll provider system 103 and/or employers through the web interface module 121, email or similar processes. In one embodiment, the reconciliation report or similar feedback is only provided when an error or similar issue is identified. The reconciliation reports can simply generate notices of out of balance transactions or similar detected errors.

The reconciliation process audits each payroll tax data file electronically to ensure receipt of balanced data. The total tax liabilities being accrued by each individual payroll tax authority and by each employer, must equal and be offset by the funding requirements of each individual employer. The individual employer funding or collection file must balance to a receivable file due and payable from each individual employer. The individual employer payroll tax disbursements file detailing electronic deposits or manual checks issued to individual tax authorities must balance to the amounts of payroll tax liabilities previously posted to the individual employer ledgers as due and payable. The payroll tax data files, the employer funding or collection files and the payroll tax disbursement files (electronic or manual) are posted as forwarded or received to the individual employer ledgers. These ledgers must balance to the bank statements received. Adjustment files must contain debits and credits to correct individual employer payroll tax ledgers and are balanced to the bank statements. The reconciliation process checks the transaction feedback data (including any transaction affecting accounts used for tax transactions) and incoming tax files to determine whether each of these requirements is met and logs those that are not met.

The tax collection agencies 135 and managed bank account system banks 129 communicate with each other and with the managed bank account system 115 through a banking network 131 or similar network. The banking network 131 can be a private or specialized network for processing banking transactions such as automated clearing house (ACH) transactions and similar banking transactions. In other embodiments, the managed bank account system 115 can be part of an open or hybrid network including aspects that are connected over a wide area network (WAN) 121 such as the Internet. The tax collection agencies 135 can be the Internal Revenue Service of the United States, state and local tax collection authorities and similar tax collection agencies. Similarly, the managed bank account system bank 129 can be any banking institution or similar authority that manages the accounts of the payroll managed bank account system 115 and through which tax funding can be managed.

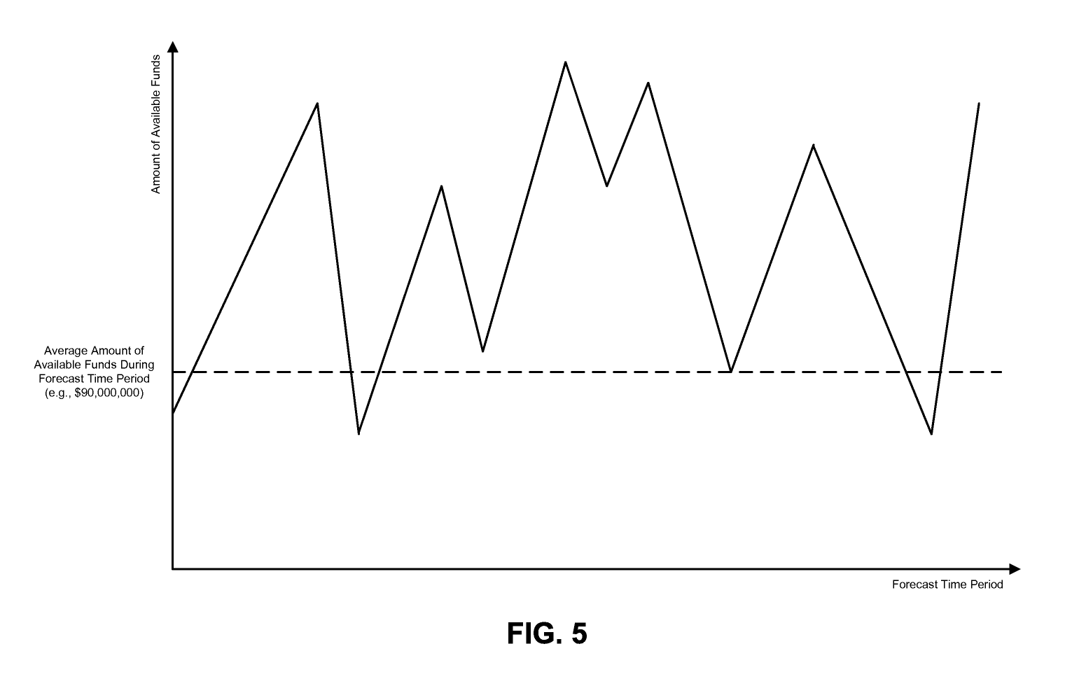

In one embodiment, the managed bank account system 115 may include an investment unit 139 for investing funds in the payroll provider bank accounts 133A and/or the employer bank accounts 133B. For example, the investment unit 139 may analyze the bank accounts 133A and/or 133B over a specified forecast time period to determine an average amount of funds available for a corresponding payroll provider and/or an employer. For example, FIG. 5 shows a graph of funds available for a corresponding payroll provider over a defined forecast time period. As shown, the time period is the previous 180 days. The funds available reflect the amount of funds transferred into a corresponding payroll provider bank account 133B in view of the liabilities for the payroll provider for this time period. In this example, the average amount of available funds available over the time period is $90,000,000. Based on this determination, the investment unit 139 may invest the average funds available over the defined time period. For example, the investment unit 139 may open one or more certificate of deposit accounts (CDs) using the $90,000,000 in average available funds. These CDs may mature in 180 days (i.e., the forecast time period). During the 180 days, if the actual available funds drop below the invested amount (e.g., $90,000,000), the investment unit 139 may automatically transfer funds into the corresponding payroll provider bank account 133A such that liabilities of the payroll provider (e.g., tax liabilities) may be paid. For example, this transfer of funds may be based on a revolving line of credit of the managed bank account system 115.

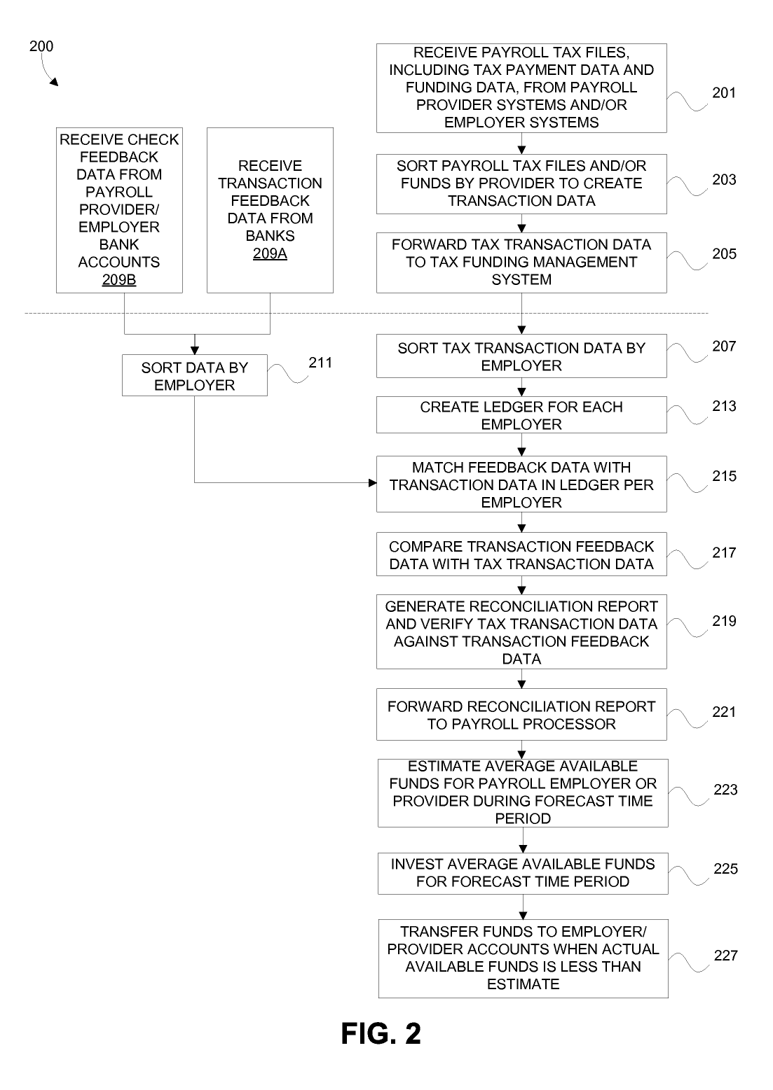

FIG. 2 is a flowchart of one embodiment of the payroll tax settlement process 200 performed by the managed bank account system 115. The process 200 can be initiated by the managed bank account system 115 receiving the payroll tax files (e.g., tax data files, tax funding files and tax disbursement files) from the payroll provider system 101 (Block 201). The payroll tax files can include the tax data files, tax funding files, and tax disbursement files. These files can be in any format or form and can be generated by any type of payroll processing service system executed by any payroll provider system 101. The contents of the payroll tax files describe transactions between employers/payroll providers and other parties, including payments to tax authorities and transfer of funds to the managed bank account system 115. The tax files can be sorted by provider to create transaction data for each provider (Block 203). Sorted transaction data, including tax payment data and/or funding data, can be forwarded to the tax funding management system through the tax funding management interface 127 (Block 205). The use and incorporation of the tax funding management system is optional. The transaction data can be further sorted to segregate the data by employer and/or employee (Block 207). In some embodiments, other payroll related data including garnishment data, retirement account data (e.g., 401(k) account data), and worker's compensation data are also received to determine how the balances of bank accounts 133A/133B associated with tax transactions are affected.

Asynchronously, the managed bank account system 115 can receive transaction data or transaction feedback data from the managed bank account system banks 129 via the banking network 131 and/or from the banks accounts 133A and/or 133B (Block 209A). This data may represent ACH and/or wire transactions. Similarly, the managed bank account system 115 can receive transaction data or check feedback data asynchronously from payroll provider bank accounts 133A and/or employer bank accounts 133B via the checking account management unit 137 (Block 209B). This data from the bank accounts 133A/133B may represent check transaction data. Since the bank accounts 133A/133B associated with these check transactions are maintained and/or are controlled by the same entity performing reconciliation services, check transactions may be accounted for during reconciliation processing through this visibility. Accordingly, reconciliation processing may be more accurately and efficiently performed while reducing risk as all transactions (i.e., both ACH/wire and check transactions) are accounted. The transaction feedback and check data can also be sorted by an employer, grouped by the employer, or similarly processed (Block 211).

The payroll transaction data can be used to create a ledger for each employer (Block 213). The ledgers can have any form or format and any number of ledgers can be generated for each employer. For example, separate ledgers can be generated for each tax agency. The ledgers include payroll tax data, such that overall balances for each tax agency and similar balance information is maintained. These ledgers can be updated over time in increments or continuously as new payroll tax data is received by the system. If balances are affected by non-tax transactions, then these transactions can also be tracked (e.g., garnishment, retirement account, worker's compensation and similar transactions).

In one embodiment, the function of the employer ledgers is to create a complete balanced accounting history of payroll tax processing for all individual employers' payroll tax liabilities, the collection of those payroll tax liabilities, and then the payment of those payroll tax liabilities to the payroll tax authority involved. This is accomplished for thousands of employers and thousands (over eight thousand) of taxing authorities. All of these transactions are ledgered and balanced to the bank account(s) of the corresponding employer. Employer ledgers maintain balanced data for the following activities: cash in bank; receivables from employers' federal withholding tax liabilities (FWT); Federal Insurance Contributions Act liabilities (FICA); federal unemployment insurance liabilities (FUI); state withholding tax liabilities (SWT by state); state unemployment insurance liabilities (SUI by state); and local taxes (city, county, occupational, educational and other) as required by taxing authorities. In some embodiments, these employer ledgers also include non-payroll tax transaction data affecting account balances such as garnishment, retirement account, worker's compensation and similar transaction data.

At defined intervals or in response to receipt of new files/funds or feedback data, the feedback data can be matched with payroll tax transaction data and any non-tax payroll transaction data affecting relevant account balances in ledgers on a per employer basis (Block 215). The transaction feedback data and payroll tax transaction data can be compared to determine whether there is a match between respective entries. Any or all the properties of these transactions such as the amount and timing of the transactions can be compared to determine whether there is a match between respective entries. Based on these comparisons, a reconciliation report can be generated (Block 217). As noted above, since check transactions are reported by the bank accounts 133A/133B maintained and/or controlled by the same entity performing reconciliation services, check transactions may be accounted for during reconciliation processing through this visibility. Accordingly, reconciliation processing may be more accurately and efficiently performed while reducing risk as all transactions (i.e., both ACH and check transactions) are accounted.

The reconciliation report provides verification for those payroll tax transactions and other non-tax transactions affecting relevant account balances in the payroll fax files and ledgers that match their corresponding transaction feedback indicating that the transaction was processed and carried through as expected and as recorded in the payroll tax transaction data. Inconsistencies or errors or unmatched transactions can also be included in the reconciliation report. These inconsistencies can then be resolved by the payroll processor. These reconciliation reports are generated on a per employer basis, further facilitating the speed and ease by which inconsistencies and errors can be corrected or the cause of these errors determined.

The reconciliation reports can be forwarded to the payroll processor upon completion or on an intermittent basis (Block 219). These reconciliation reports can be automatically provided to the payroll processor through direct messaging such as through an email or can be made available through the web-based interface. The reconciliation report can have any format or form. The detail provided in the reconciliation report can vary and can include transaction identification information, transaction details (e.g., time of transaction, amount of transaction), employer identification, payroll provider system identification, tax processor system identification and similar information. These reports can be an accumulation of separate errors or notifications or they can be generated and issued for each separate error or notification.

In one embodiment, the investment unit 139 may determine the average funds available for a payroll employer or payroll provider (Block 223). The average funds available may be determined over a forecast time period by examining the bank accounts 113A or 113B. The average funds available may be invested using one or more financial services (Block 225). Following the investment, upon determining that the actual funds available for the payroll provider or employer is below the estimated average funds available, the investment unit 139 may trigger the movement of funds to cover the deficiency (Block 227). For example, when the average funds available was determined to be $90,000,000, but after the available funds are invested, the actual available funds at a particular point in time are only $80,000,000, the investment unit 139 may retrieve the remaining $10,000,000 from a line of credit issued to the managed bank account system 115. This transfer may be from the managed bank account banks 129 to one of the bank accounts 113A or 113B.

As described above, by investing available funds for payroll providers and/or employers, the method 200 ensures that stored funds are utilized without significant risk of failing to meet payment obligations (e.g., tax obligations). In particular, by investing only the average available funds for a forecast time period, which is used as the investment time period, and automatically transferring funds to meet obligations when available funds drop below the average available funds, the method 200 efficiently utilizes available funds with minimal risk.

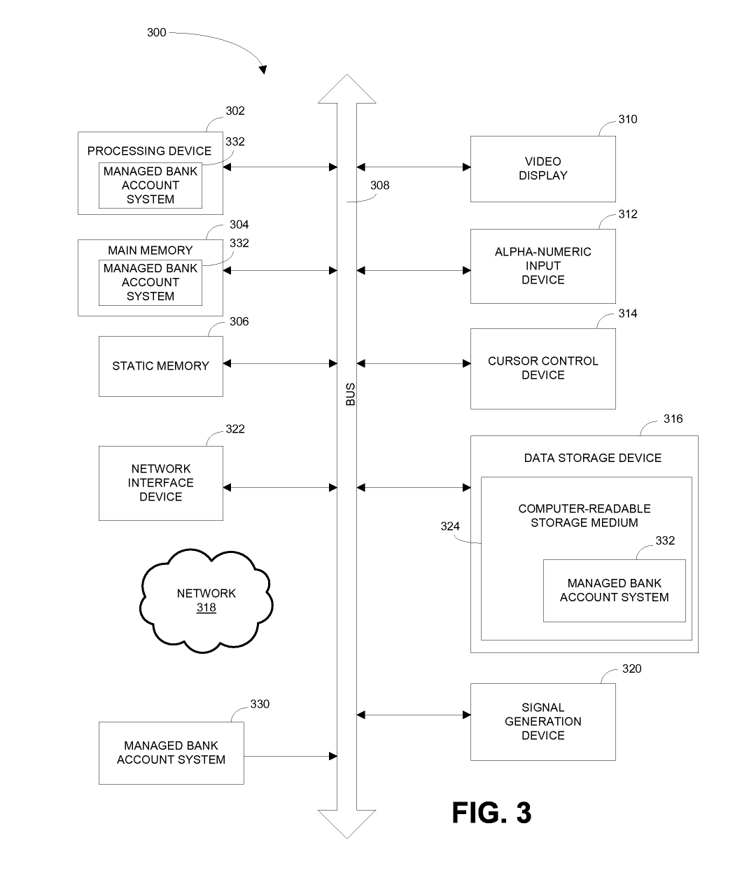

FIG. 3 is a diagram of one embodiment of a managed bank account system or a system implementing a payroll tax settlement service using a managed bank account system. Within the computer system 300 is a set of instructions for causing the computer or other machine to perform any one or more of the methodologies discussed herein. In alternative embodiments, the computer system 300 may be connected (e.g., networked) to other machines in a LAN, an intranet, an extranet, or the Internet. The computer system 300 can operate in the capacity of a server or a client machine (e.g., a client computer executing a code patcher module and a server computer executing a computer module) in a client-server network environment, or as a peer machine in a peer-to-peer (or distributed) network environment. The machine may be a personal computer (PC), a tablet PC, a console device or set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single computer is illustrated, the term “computer” shall also be taken to include any collection of computers or other machines that individually or jointly execute a set (or multiple sets) of instructions to perform any one or more of the methodologies discussed herein.

The exemplary computer system 300 includes a processing device 302, a main memory 304 (e.g., read-only memory (ROM), flash memory, dynamic random access memory (DRAM) such as synchronous DRAM (SDRAM) or Rambus DRAM (RDRAM), etc.), a static memory 306 (e.g., flash memory, static random access memory (SRAM), etc.), and a secondary memory 316 (e.g., a data storage device in the form of a drive unit, which can include fixed or removable computer-readable storage medium), which communicate with each other via a bus 308.

The processing device 302 represents one or more general-purpose processing devices such as a microprocessor, central processing unit, or the like. More particularly, the processing device 302 can be a complex instruction set computing (CISC) microprocessor, reduced instruction set computing (RISC) microprocessor, very long instruction word (VLIW) microprocessor, processor implementing other instruction sets, or processors implementing a combination of instruction sets. In another embodiment, the processing device 402 can also be one or more special-purpose processing devices such as an application specific integrated circuit (ASIC), a field programmable gate array (FPGA), a digital signal processor (DSP), network processor, or the like. The processing device 302 is configured to execute the managed bank account system 332 for performing the operations and steps discussed herein.

The computer system 300 can further include a network interface device 322. The computer system 300 also can include a video display unit 310 (e.g., a liquid crystal display (LCD) or a cathode ray tube (CRT)) connected to the computer system through a graphics port and graphics chipset, an alphanumeric input device 312 (e.g., a keyboard), a cursor control device 314 (e.g., a mouse), and a signal generation device 320 (e.g., a speaker).

The secondary memory 316 can include a machine-readable storage medium (or more specifically a computer-readable storage medium) 324 on which is stored one or more sets of instructions (e.g., the managed bank account system 332) embodying any one or more of the methodologies or functions described herein. The managed bank account system 332 can also reside, completely or at least partially, within the main memory 304 and/or within the processing device 302 during execution thereof by the computer system 300, the main memory 304 and the processing device 302 also constituting machine-readable storage media. The managed bank account system 332 can further be transmitted or received over a network 318 via the network interface device 322.

The machine-readable storage medium 324 can also be used to store the managed bank account system 332 persistently. While the machine-readable storage medium 324 is shown in an exemplary embodiment to be a single medium, the term “machine-readable storage medium” and also “computer-readable storage medium” should be taken to include a single medium or multiple media (e.g., a centralized or distributed database, and/or associated caches and servers) that store the one or more sets of instructions. The terms “machine-readable storage medium” and “computer-readable storage medium” shall also be taken to include any medium that is capable of storing or encoding a set of instructions for execution by the machine and that cause the machine to perform any one or more of the methodologies of the present invention. The terms “machine-readable storage medium” and “computer-readable storage medium” shall accordingly be taken to include, but not be limited to, solid-state memories, and optical and magnetic media.

In one embodiment, the managed bank account system 330 can be implemented as a separate hardware component such as application specific integrated circuits (ASICs). The managed bank account system 330 can communicate with the other components over the bus 308.

In the above description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” “creating,” “sending,” “generating,” or the like, refer to the actions and processes of a computer system, or similar electronic computing device that manipulates and transforms data represented as physical (electronic) quantities within the computer system's registers and memories into other data similarly represented as physical quantities within the computer system memories, registers or other such information storage, transmission or display devices.

The present invention also relates to an apparatus for performing the operations herein. This apparatus may be specially constructed for the required purposes or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, Flash memory devices including universal serial bus (USB) storage devices (e.g., USB key devices) or any type of media suitable for storing electronic instructions, each of which may be coupled to a computer system bus.

The algorithms and displays presented herein are not inherently related to any particular computer or other apparatus. Various general purpose systems may be used with programs in accordance with the teachings herein or it may prove convenient to construct more specialized apparatus to perform the required method steps. The required structure for a variety of these systems has been described in the description above. In addition, the present invention is not described with reference to any particular programming language. It will be appreciated that a variety of programming languages may be used to implement the teachings of the invention as described herein. Further, while software and hardware embodiments have described herein to illustrate the range of possible implementations, those skilled in the art would understand that any combination of these techniques can be utilized, such that the invention would not have an entirely hardware or software implementation, for example, any of the functions or algorithms described herein could be implemented in micro-coded hardware components.

Thus, a method and apparatus for payroll tax settlement has been described. It is to be understood that the above description is intended to be illustrative and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A method comprising:
receiving payroll tax files from a payroll provider system, the payroll tax files including payroll tax transaction data for a plurality of employers;
receiving a first set of transaction feedback data from a checking account management unit of a computer-implemented managed bank account system, the first set of transaction feedback data providing completion and error information on checks dispensed by the payroll provider system to a first set of tax authorities from an account managed by the computer-implemented managed bank account system;
creating a ledger for each employer in the plurality of employers using the payroll tax transaction data from the payroll tax files; and
executing by the computer-implemented managed bank account system a reconciliation process by matching the first set of transaction feedback data with each employer and comparing the first set of transaction feedback data with the ledgers of the corresponding employer.

2. The method of claim 1, further comprising:
receiving a second set of transaction feedback data from a banking network, the second set of transaction feedback data providing completion and error information on clearing house payroll tax transactions or wire transactions between the payroll provider system and a second set of tax authorities,
wherein the reconciliation process is further executed by matching the second set of transaction feedback data with each employer and comparing the second set of transaction feedback data with the ledgers of the corresponding employer.

3. The method of claim 2, further comprising:
generating a reconciliation report for errors found in the reconciliation process; and
providing the reconciliation report to the payroll provider system or a payroll employer system.

4. The method of claim 2, wherein comparing transaction data further comprises:
identifying tax funding transactions in the payroll tax files; and
forwarding the tax funding transactions to a tax funding management system.

5. The method of claim 2, further comprising:
providing checking services to the payroll provider system for the account managed by the computer-implemented managed bank account system, wherein the checking services for the account managed by the computer-implemented managed bank account system allow the payroll provider system to draft checks to the first set of tax authorities.

6. The method of claim 4, further comprising:
estimating an average amount of funds available for the provider system in the account based on the tax funding transactions and the payroll tax transaction data, wherein the estimated average amount of funds available for the provider system is relative to a specified forecast time period; and
investing the estimated average amount of funds available for the forecast time period.

7. The method of claim 6, further comprising:
detecting an actual amount of available funds available for the payroll provider system during the forecast time period is below the estimated average amount of funds available for the payroll provider system; and
transferring, in response to detecting the actual amount of available funds available for the payroll provider system is below the estimated average amount of funds available, the difference between the estimated average amount of funds available and the actual amount of available funds into the account from an account of the managed bank account system.

8. A managed bank account system comprising:
a ledger management module to generate a ledger per employer from received payroll tax files from a payroll provider system;
a checking account management unit communicatively coupled to the ledger management module, the checking account management unit to receive a first set of transaction feedback data from a bank account managed by the managed bank account system, wherein the first set of transaction feedback data is related checks dispensed by the payroll provider system to a first set of tax authorities from an account managed by the managed bank account system;
a reconciliation report manager to compare the ledger of each employer to the first set of transaction feedback data and to match each transaction in the first set of transaction feedback data with an employer to verify accuracy of the payroll tax file for each employer.

9. The managed bank account system of claim 8, further comprising:
a bank transaction management module communicatively coupled to the ledger management module, the bank transaction module to receive a second set of transaction feedback data from a bank, wherein the second set of transaction feedback data provides completion and error information on clearing house payroll tax transactions or wire transactions between the payroll provider system and a second set of tax authorities,
wherein the reconciliation report manager to compare the ledger of each employer to the second set of transaction feedback data and to match each transaction in the second set of transaction feedback data with an employer to verify accuracy of the payroll tax file for each employer.

10. The managed bank account of claim 8, further comprising:
a tax funding management interface to forward tax funding transactions to a tax funding management system to manage a tax funding for a corresponding employer.

11. The managed bank account system of claim 8, wherein the reconciliation report manager generates a reconciliation report including at least one error found by the reconciliation report manager.

12. The managed bank account system of claim 8, the checking account management unit to further provide checking services to the payroll provider system for the account managed by the managed bank account system, wherein the checking services for the account managed by the managed bank account system allow the payroll provider system to draft checks to the first set of tax authorities.

13. The managed bank account system of claim 8, further comprising:
an investment unit to estimate an average amount of funds available for the provider system in the account based on tax funding transaction data and payroll tax transaction data provided by the payroll tax files, wherein the estimated average amount of funds available for the provider system is relative to a specified forecast time period; and
investing the estimated average amount of funds available for the forecast time period.

14. An article of manufacture, comprising:
a non-transitory machine-readable storage medium that stores instructions which, when executed by a processor in a computer,
receive payroll tax files from a payroll provider system, the payroll tax files including payroll tax transaction data for a plurality of employers;
receive a first set of transaction feedback data from a checking account management unit of a computer-implemented managed bank account system, the first set of transaction feedback data providing completion and error information on checks dispensed by the payroll provider system to a first set of tax authorities from an account managed by the computer-implemented managed bank account system;
create a ledger for each employer in the plurality of employers using the payroll tax transaction data from the payroll tax files; and
execute by the computer-implemented managed bank account system a reconciliation process by matching the first set of transaction feedback data with each employer and comparing the first set of transaction feedback data with the ledgers of the corresponding employer.

15. The non-transitory machine-readable medium of claim 14, wherein the non-transitory machine-readable storage medium stores further instructions which, when executed by the processor:
receive a second set of transaction feedback data from a banking network, the second set of transaction feedback data providing completion and error information on clearing house payroll tax transactions or wire transactions between the payroll provider system and a second set of tax authorities,
wherein the reconciliation process is further executed by matching the second set of transaction feedback data with each employer and comparing the second set of transaction feedback data with the ledgers of the corresponding employer.

16. The non-transitory machine-readable medium of claim 13, wherein the non-transitory machine-readable storage medium stores further instructions which, when executed by the processor:
generate a reconciliation report for errors found in the reconciliation process; and
provide the reconciliation report to the payroll provider system or a payroll employer system.

17. The non-transitory machine-readable medium of claim 15, wherein the non-transitory machine-readable storage medium stores further instructions which, when executed by the processor:
identify tax funding transactions in the payroll tax files; and
forward the tax funding transactions to a tax funding management system.

18. The non-transitory machine-readable medium of claim 14, wherein the non-transitory machine-readable storage medium stores further instructions which, when executed by the processor:
provide checking services to the payroll provider system for the account managed by the computer-implemented managed bank account system, wherein the checking services for the account managed by the computer-implemented managed bank account system allow the payroll provider system to draft checks to the first set of tax authorities.

19. The non-transitory machine-readable medium of claim 15, wherein the non-transitory machine-readable storage medium stores further instructions which, when executed by the processor:
estimate an average amount of funds available for the provider system in the account based on the tax funding transactions and the payroll tax transaction data, wherein the estimated average amount of funds available for the provider system is relative to a specified forecast time period; and
invest the estimated average amount of funds available for the forecast time period.

20. The non-transitory machine-readable medium of claim 19, wherein the non-transitory machine-readable storage medium stores further instructions which, when executed by the processor:
detect an actual amount of available funds available for the payroll provider system during the forecast time period is below the estimated average amount of funds available for the payroll provider system; and
transfer, in response to detecting the actual amount of available funds available for the payroll provider system is below the estimated average amount of funds available, the difference between the estimated average amount of funds available and the actual amount of available funds into the account from an account of the managed bank account system.
